(19) United States
(12) Patent Application Publication
(10) Pub. No.: US 2021/0015298 A1
(43) Pub. Date: Jan. 21, 2021

(54) TEMPERATURE CONTROL METHOD AND APPARATUS FOR COOKWARE, AND COOKWARE AND STORAGE MEDIUM

(71) Applicant: FOSHAN SHUNDE MIDEA ELECTRICAL HEATING APPLIANCES MANUFACTURING CO., LTD., Foshan (CN)

(72) Inventors: Zhibo XU, Foshan (CN); Fenglei XING, Foshan (CN); Weiwei CHEN, Foshan (CN); Peng BI, Foshan (CN); Xiubao LIN, Foshan (CN); Maozhen SHAN, Foshan (CN)

(21) Appl. No.: 17/040,021

(22) PCT Filed: Aug. 27, 2018
(86) PCT No.: PCT/CN2018/102488

§ 371 Date: Sep. 21, 2020

(30) Foreign Application Priority Data
Mar. 22, 2018 (CN) 201810242383.1

(51) Int. Cl. A47J 36/32; A47J 37/10; G05D 23/20

(52) U.S. Cl. CPC A47J 36/32; G05D 23/20; A47J 37/105

(57) ABSTRACT

A temperature control method for a cookware includes collecting temperature values detected by a plurality of temperature sensors arranged at different positions of a heating area of the cookware, determining a minimum temperature value and a maximum temperature value of the heating area from among the collected temperature values, starting a heating device in response to the minimum temperature value and the maximum temperature value of the heating area satisfying a preset temperature increase condition, and stopping the heating device in response to the minimum temperature value and the maximum temperature value of the heating area satisfying a preset temperature reduction condition.

### CROSS-REFERENCE TO RELATED APPLICATION

The present application is based upon and claims the benefit of priority from Chinese Patent Application No. 201810242383.1, filed on Mar. 22, 2018, the entire content of which is incorporated herein by reference.

### TECHNICAL FIELD

The disclosure relates to the technology of temperature control, and in particular to a temperature control method and a temperature control apparatus for a cookware, a cookware and a storage medium.

### BACKGROUND

For most existing baking machines, the temperature sensor disposed at the center position of the baking tray, and the temperature sensor directly detects the temperature of the center of the baking tray. After preheating, a food is placed on the baking tray for cooking. When the food is just placed in a central region of the baking tray, since the food itself has a relatively low temperature, the food would absorb quickly the heat from the central region of the baking tray, thereby reducing the temperature of the central region of the baking tray. When the temperature sensor detects that the temperature of the baking tray has been reduced to the lowest temperature threshold value, a heating device is started to work, so that the working temperature of the baking tray is in a normal working range, so as to ensure the cooking effect of the food. However, when the food is placed on an edge region of the baking tray, the food would absorb the heat from the edge region of the baking tray, which has a relatively small effect on the temperature of the center region of the baking tray in a short period of time, and thus the temperature sensor in the center region of the baking tray cannot detect the temperature reduction of the baking tray in time. Accordingly, the operation of the heating device cannot be controlled in time, so that the baking tray cannot provide a reliable cooking temperature for the food.

### SUMMARY

The embodiments of the disclosure are expected to provide a temperature control method and a temperature control apparatus for a cookware, a cookware and a storage medium, to improve the flexibility of temperature control and improve the intelligent level of the cookware.

The technical solutions of the disclosure are implemented as follows.

The embodiments of the disclosure provide a temperature control method for a cookware, the cookware including a first heating device and a plurality of temperature sensors arranged at different positions of a first heating area; the method including the following steps:
temperature values detected by the plurality of temperature sensors are collected;
a minimum temperature value and a maximum temperature value of the first heating area are determined from all the collected temperature values;
the first heating device is started if the minimum temperature value and the maximum temperature value of the first heating area satisfy a preset temperature increase condition; and
the first heating device is stopped if the minimum temperature value and the maximum temperature value of the first heating area satisfy a preset temperature reduction condition.

In the above solution, the temperature increase condition includes: the minimum temperature value being less than a lowest temperature threshold value, and the maximum temperature value being less than a highest temperature threshold value.

In the above solution, the temperature reduction condition includes: the minimum temperature value being greater than or equal to a lowest temperature threshold value, or the maximum temperature value being greater than or equal to a highest temperature threshold value.

In the above solution, the method further includes the following steps: the lowest temperature threshold value and the highest temperature threshold value corresponding to each working mode of the cookware are preset; and the lowest temperature threshold value and the highest temperature threshold value of the cookware in a current working mode are determined.

In the above solution, the cookware further includes: a second heating device to an N^{th} heating device, and a plurality of temperature sensors arranged at different positions of an i^{th} heating area. The i^{th} heating area corresponds to an i^{th} heating device, in which i is an integer of 2 to N. The method further includes the following steps: temperature values detected by the plurality of temperature sensors in the i^{th} heating area are collected; a minimum temperature value and a maximum temperature value of the i^{th} heating area are determined from all the collected temperature values; the i^{th} heating device is started if the minimum temperature value and the maximum temperature value of the i^{th} heating area satisfy the preset temperature increase condition; and the i^{th} heating device is stopped if the minimum temperature value and the maximum temperature value of the i^{th} heating area satisfy the preset temperature reduction condition.

In the above solution, the method further includes the following steps: the lowest temperature threshold value and the highest temperature threshold value corresponding to each working mode of each heating area are preset; and the lowest temperature threshold value and the highest temperature threshold value of each heating area in a current working mode are determined.

In the above solution, the plurality of temperature sensors are in a form of a radial distribution or a lattice distribution.

The embodiments of the disclosure further provide a temperature control apparatus for a cookware. The cookware includes a first heating device and a plurality of temperature sensors arranged at different positions of a first heating area. The temperature control apparatus includes a first processor and a first memory.

The first processor is configured to execute temperature control programs stored in the first memory to implement the following steps: temperature values detected by the plurality of temperature sensors are collected; a minimum temperature value and a maximum temperature value of the first heating area are determined from all the collected temperature values; the first heating device is started if the minimum temperature value and the maximum temperature value of the first heating area satisfy a preset temperature increase condition; and the first heating device is stopped if the minimum temperature value and the maximum temperature value of the first heating area satisfy a preset temperature reduction condition.

The embodiments of the disclosure further provide a cookware. The cookware includes a second processor, a second memory, a first heating device, and a plurality of temperature sensors arranged at different positions of a first heating area. The second processor is configured to execute temperature control programs stored in the second memory to implement the following steps:
temperature values detected by the plurality of temperature sensors are collected;
a minimum temperature value and a maximum temperature value of the first heating area are determined from all the collected temperature values;
the first heating device is started if the minimum temperature value and the maximum temperature value of the first heating area satisfy a preset temperature increase condition; and
the first heating device is stopped if the minimum temperature value and the maximum temperature value of the first heating area satisfy a preset temperature reduction condition.

The embodiments of the disclosure further provide a computer readable storage medium having computer programs stored thereon, in which steps of the method of any one of the above embodiments are implemented when the computer programs are executed by a processor.

The embodiments of the disclosure provide a temperature control method and a temperature control apparatus for a cookware, a cookware and a storage medium. The cookware includes a first heating device and a plurality of temperature sensors arranged at different positions of a first heating area. The method includes the following steps: temperature values detected by the plurality of temperature sensors are collected; a minimum temperature value and a maximum temperature value of the first heating area are determined from all the collected temperature values; the first heating device is started if the minimum temperature value and the maximum temperature value of the first heating area satisfy a preset temperature increase condition; and the first heating device is stopped if the minimum temperature value and the maximum temperature value of the first heating area satisfy a preset temperature reduction condition.

By adopting the above technical solutions, the temperature of the heating area can be synthetically judged based on the temperature values detected by the plurality of temperature sensors. The heating device is started if the temperature increase condition is satisfied, so as to increase the temperature of the heating area to ensure the cooking effect of the food. The heating device is stopped if the temperature reduction condition is satisfied, so as to reduce the temperature of the heating area to ensure the safety of the cookware. In this way, the flexibility of temperature control is improved, and the intelligent level of the cookware is improved.

### BRIEF DESCRIPTION OF THE DRAWINGS

FIG. 1 is a flow chart of a first embodiment of a temperature control method for a cookware in embodiments of the disclosure;

FIG. 2 is a schematic structural diagram of a cookware in embodiments of the disclosure;

FIG. 3 is a flow chart of a second embodiment of a temperature control method for a cookware in embodiments of the disclosure;

FIG. 4 is a schematic structural diagram of a temperature control apparatus of a cookware in embodiments of the disclosure;

FIG. 5 is a schematic structural diagram of a cookware in embodiments of the disclosure.

### DETAILED DESCRIPTION

Hereinafter, the technical solutions in the embodiments of the disclosure will be described clearly and completely in combination with the accompanying drawings in the embodiments of the disclosure.

First Embodiment

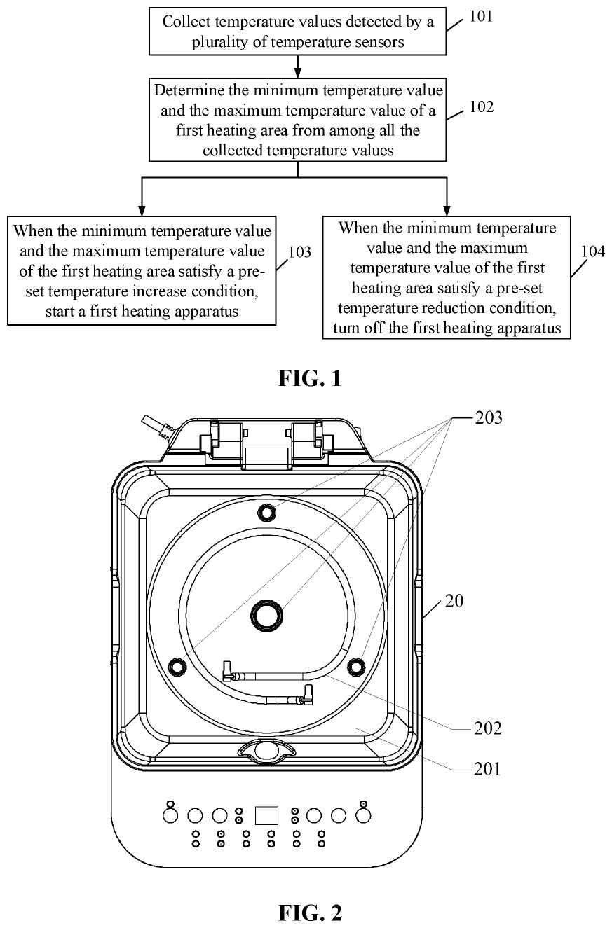

In the first embodiment, a cookware includes a first heating device and a plurality of temperature sensors arranged at different positions of a first heating area. Herein, the first heating device is configured to heat the first heating area, and the cookware may be a home kitchen appliance such as a baking machine, a steak machine, an induction cooker, a rice cooker or the like. FIG. 1 is a flow chart of the first embodiment of a temperature control method for a cookware in embodiments of the disclosure. As shown in FIG. 1, the method includes the following steps.

In step 101, temperature values detected by the plurality of temperature sensors are collected.

As an example, when the heating area is a baking tray, the food is in contact with an outer surface of the baking tray, and the plurality of temperature sensors are in contact with an inner surface of the baking tray to detect the working temperature of the baking tray.

Specifically, the plurality of temperature sensors may be in a form of a radial distribution or a lattice distribution. The radial distribution includes a center position of the heating area and equally-spaced positions on a circumference of a circle that spreads outward from the center position by at least a radius. The lattice distribution includes a plurality of lattice positions with an equal row spacing and an equal column spacing.

FIG. 2 is a schematic structural diagram of a cookware in embodiments of the disclosure. As shown in FIG. 2, the cookware is a baking machine. The baking machine 20 includes: a baking tray 201, a heating device 202 and a plurality of temperature sensors 203, in which the baking tray is the heating area in the embodiments of the disclosure, and the food is placed on the baking tray to implement the cooking operation. The plurality of temperature sensors 203, which are distributed in a radiation pattern, particularly include: a primary temperature sensor at the center position, and three secondary temperature sensors evenly distributed on a circumference of a circle that spreads outward from the center position by a radius. The primary temperature sensor is configured to detect the temperature at the center of the baking tray, and each of the three secondary temperature sensors is configured to detect the temperature at the edge of the baking tray.

In step 102, a minimum temperature value and a maximum temperature value of the first heating area are determined from all the collected temperature values.

Herein, temperature values of the first heating area include T1, T2 to Tm. A number of m temperature values are compared to determine the minimum temperature value Tmin and the maximum temperature value Tmax. The two values can be used as a basis for controlling the starting and stopping of the first heating device, to improve the reliability of temperature control.

In step 103, the first heating device is started if the minimum temperature value and the maximum temperature value of the first heating area satisfy a preset temperature increase condition.

As an example, the temperature increase condition includes: the minimum temperature value being less than a lowest temperature threshold value, and the maximum temperature value being less than a highest temperature threshold value. Herein, before the first heating device is started, the first heating device is in a stopped state. Therefore, it is necessary to start the first heating device to increase the temperature of the first heating area.

As an example, the first heating device may be an electrical heating tube, a heater with a Positive Temperature Coefficient (PTC) characteristic, or an electrical heating film, etc.

In step 104, the first heating device is stopped if the minimum temperature value and the maximum temperature value of the first heating area satisfy a preset temperature reduction condition.

As an example, the temperature reduction condition includes: the minimum temperature value being greater than or equal to a lowest temperature threshold value, or the maximum temperature value being greater than or equal to a highest temperature threshold value. Herein, before the first heating device is stopped, the first heating device is in a working state. Therefore, it is necessary to stop the first heating device to reduce the temperature of the first heating area.

Optionally, the lowest temperature threshold value may be determined according to the minimum temperature value which guarantees the cooking effect of the food when the cookware is working, and the highest temperature threshold value may be determined according to the maximum temperature value which is allowed when the cookware is working. For example, since there are differences in sensitivities of the sensors and in temperatures of cooking ingredients, the range of the minimum temperature value may be set between 150° C. and 210° C., preferably 180° C. In order to ensure that the baking machine works safely, a preset protection temperature of the baking tray is set between 250° C. and 300° C., and the maximum temperature value may be 250° C.

In another optional embodiment, both the lowest temperature threshold value and the highest temperature threshold value may be determined according to a working mode selected in the cookware. For example, the cookware in a working mode has a corresponding temperature range. An upper limit value of the temperature range is the highest temperature threshold value and a lower limit value of the temperature range is the lowest temperature threshold value. For example, the working modes of the baking machine include: a steak mode, a pancake mode, a fried egg mode and the like. A temperature range corresponding to the steak mode is between 185° C. and 205° C., in which the highest temperature threshold value is 205° C., and the lowest temperature threshold value is 185° C. A temperature range corresponding to the pancake mode is between 180° C. and 200° C., in which the highest temperature threshold value is 200° C., and the lowest temperature threshold value is 180° C. A temperature range corresponding to the fried egg mode is between 170° C. and 190° C., in which the highest temperature threshold value is 190° C., and the lowest temperature threshold value is 170° C.

Thus, the temperature control method in the embodiment of the disclosure may further includes the following steps: the lowest temperature threshold value and the highest temperature threshold value corresponding to each working mode of the cookware are preset; and the lowest temperature threshold value and the highest temperature threshold value of the cookware in the current working mode are determined.

In an actual implementation, the heating device is started, if Tmin is less than a preset lowest temperature threshold value TL and Tmax is less than a preset highest temperature threshold value TH; or else, the heating device is stopped, if Tmin is greater than or equal to the preset lowest temperature threshold value TL or Tmax is greater than or equal to the highest temperature threshold value TH. During the entire cooking process, cooking programs intermittently read the temperature values of all the temperature sensors, and judge whether to start or stop heating according to the above method until timing of the cooking program is over.

In the embodiments of the disclosure, step 101 to step 104 may be performed by a processor of the cookware, or performed by a processor of a temperature control apparatus for the cookware. The performing order of step 103 and step 104 as well as whether to perform step 103 and step 104 are not limited by the embodiments of the disclosure, but are determined based on the collected minimum temperature value and maximum temperature value.

In the embodiments of the disclosure, the cookware includes a first heating device and a plurality of temperature sensors arranged at different positions of a first heating area. The method includes the following steps: temperature values detected by the plurality of temperature sensors are collected; a minimum temperature value and a maximum temperature value of the first heating area are determined from all the collected temperature values; the first heating device is started if the minimum temperature value and the maximum temperature value of the first heating area satisfy a preset temperature increase condition; and the first heating device is stopped if the minimum temperature value and the maximum temperature value of the first heating area satisfy a preset temperature reduction condition.

By adopting the above technical solutions, the temperature of the heating area can be synthetically judged based on the temperature values detected by the plurality of temperature sensors. The heating device is started if the temperature increase condition is satisfied, so as to increase the temperature of the heating area to ensure the cooking effect of the food. The heating device is stopped if the temperature reduction condition is satisfied, so as to reduce the temperature of the heating area to ensure the safety of the cookware. In this way, the flexibility of temperature control is improved, and the intelligent level of the cookware is improved.

Second Embodiment

In order to better reflect the purpose of the disclosure, the disclosure is further exemplified on the basis of the first embodiment of the disclosure.

In the second embodiment, the cookware includes: a first heating device, a second heating device to an N^{th} heating device, and a plurality of temperature sensors arranged at different positions of an i^{th} heating area. The i^{th} heating area corresponds to an i^{th} heating device, in which i is an integer of 1 to N. The i^{th} heating device is configured to heat the i^{th} heating area. The i^{th} heating device to the N^{th} heating device may be electrical heating tubes, heaters with PTC characteristic, or electrical heating films etc., and may be the same device or different devices.

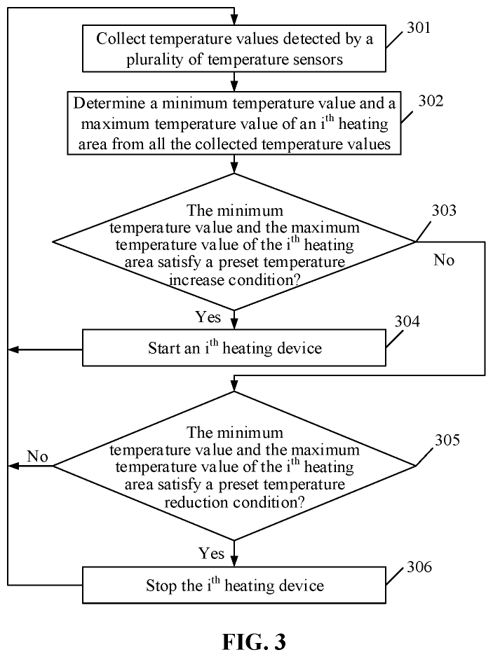

FIG. 3 is a flow chart of the second embodiment of a temperature control method for a cookware in embodiments of the disclosure. The method includes the following steps.

In step 301, temperature values detected by the plurality of temperature sensors are collected.

Herein, the temperature values detected by all of the temperature sensors on the cookware may be collected, or the temperature values detected by the temperature sensors in part of the heating areas may be collected.

In step 302, a minimum temperature value and a maximum temperature value of the i^{th} heating area are determined from all the collected temperature values.

Herein, the minimum temperature values and the maximum temperature values of the first heating area to the N^{th} heating area may be determined successively. The minimum temperature value and the minimum temperature value of each heating area may also be determined, and the heating device corresponding to each heating area may be controlled according to the determined maximum and minimum temperature values.

In addition, the first heating area to the N^{th} heating area may be set flexibly according to the use of the cookware. For example, an upper baking tray of the baking machine is divided into several heating areas, or a lower baking tray of the baking machine is divided into several heating areas.

In step 303, it is judged whether the minimum temperature value and the maximum temperature value of the i^{th} heating area satisfy the preset temperature increase condition. If it is, step 304 is performed; if it is not, step 305 is performed.

As an example, the temperature increase condition includes: the minimum temperature value of the i^{th} heating area being less than a lowest temperature threshold value, and the maximum temperature value of the i^{th} heating area being less than a highest temperature threshold value.

In step 304, the i^{th} heating device is started.

After step 304 is performed, step 301 is returned, so as to continue to collect temperature values detected by the plurality of temperature sensors at the next time, thereby achieving real-time monitoring of the temperature of the first heating area to the temperature of the N^{th} heating area.

In step 305, it is judged whether the minimum temperature value and the maximum temperature value of the i^{th} heating area satisfy the preset temperature reduction condition. If it is, step 306 is performed; if it is not, step 301 is returned.

As an example, the temperature reduction condition includes: the minimum temperature value of the i^{th} heating area being greater than or equal to the lowest temperature threshold value, or the maximum temperature value of the i^{th} heating area being greater than or equal to the highest temperature threshold value.

In step 306, the i^{th} heating device is stopped.

After step 306 is performed, the process returns to step 301, so as to continue to collect temperature values detected by the plurality of temperature sensors at the next time, thereby achieving real-time monitoring of the temperature of the first heating area to the temperature of the N^{th} heating area until the cookware is stopped. Therefore, no matter which heating area the food is placed in, temperature change of the heating area may be detected in time, and heating is controlled according to the temperature change. In addition, the accuracy of temperature control in the heating areas may be improved by controlling independently starting and stopping of the plurality of heating devices.

Optionally, the lowest temperature threshold value and the highest temperature threshold value corresponding to each working mode of each heating area is preset; and the lowest temperature threshold value and the highest temperature threshold value of each heating area in the current working mode are determined.

In the embodiment of the disclosure, a plurality of temperature sensors are arranged at different positions of the first heating area to the N^{th} heating area, to detect temperature values at different positions. In this way, no matter which one of the heating areas the food or the cooker is placed in, temperature change of the heating area may be detected in time, and starting or stopping of the heating device may be controlled according to the temperature change, so as to ensure that the heating area may provide a uniform temperature and improve the cooking effect.

Third Embodiment

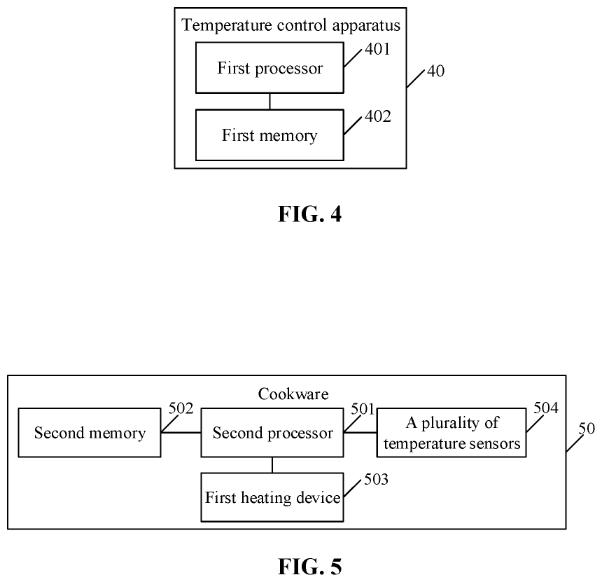

Based on the same inventive concept, the embodiments of the disclosure further provide a temperature control apparatus for a cookware. The cookware includes a first heating device and a plurality of temperature sensors arranged at different positions of a first heating area. FIG. 4 is a schematic structural diagram of a temperature control apparatus of a cookware in embodiments of the disclosure. As shown in FIG. 4, the temperature control apparatus 40 includes a first processor 401 and a first memory 402.

The first processor 401 is configured to execute temperature control programs stored in the first memory 402 to implement the following steps:
temperature values detected by the plurality of temperature sensors are collected;
a minimum temperature value and a maximum temperature value of the first heating area are determined from all the collected temperature values;
the first heating device is started if the minimum temperature value and the maximum temperature value of the first heating area satisfy a preset temperature increase condition; and
the first heating device is stopped if the minimum temperature value and the maximum temperature value of the first heating area satisfy a preset temperature reduction condition.

In an actual implementation, the temperature increase condition includes: the minimum temperature value being less than a lowest temperature threshold value, and the maximum temperature value being less than a highest temperature threshold value.

In an actual implementation, the temperature reduction condition includes: the minimum temperature value being greater than or equal to a lowest temperature threshold value, or the maximum temperature value being greater than or equal to a highest temperature threshold value.

In an actual implementation, the first processor 401 is configured to execute temperature control programs stored in the first memory 402 to implement the following steps: the lowest temperature threshold value and the highest temperature threshold value corresponding to each working mode of the cookware are preset; and the lowest temperature threshold value and the highest temperature threshold value of the cookware in the current working mode are determined.

In an actual implementation, the cookware further includes: a second heating device to an N^{th} heating device, and a plurality of temperature sensors arranged at different positions of an i^{th} heating area. The i^{th} heating area corresponds to an i^{th} heating device, in which i is an integer of 2 to N. The first processor 401 is also configured to execute temperature control programs stored in the first memory 402 to implement the following steps: temperature values detected by the plurality of temperature sensors in the i^{th} heating area are collected; a minimum temperature value and a maximum temperature value of the i^{th} heating area are determined from all the collected temperature values; the i^{th} heating device is started if the minimum temperature value and the maximum temperature value of the i^{th} heating area satisfy the preset temperature increase condition; and the i^{th} heating device is stopped if the minimum temperature value and the maximum temperature value of the i^{th} heating area satisfy the preset temperature reduction condition.

In an actual implementation, the first processor 401 is also configured to execute temperature control programs stored in the first memory 402 to implement the following steps: the lowest temperature threshold value and the highest temperature threshold value corresponding to each working mode of each heating area are preset; and the lowest temperature threshold value and the highest temperature threshold value of each heating area in the current working mode are determined.

In an actual implementation, the plurality of temperature sensors are in a form of a radial distribution or a lattice distribution.

Fourth Embodiment

Based on the same inventive concept, the embodiments of the disclosure further provide a cookware. FIG. 5 is a schematic structural diagram of a cookware in embodiments of the disclosure. As shown in FIG. 5, the cookware 50 includes: a second processor 501, a second memory 502, a first heating device 503, and a plurality of temperature sensors 504 arranged at different positions of a first heating area.

The second processor 501 is configured to execute temperature control programs stored in the second memory 502 to implement the following steps:
temperature values detected by the plurality of temperature sensors are collected;
a minimum temperature value and a maximum temperature value of the first heating area are determined from all the collected temperature values;
the first heating device is started if the minimum temperature value and the maximum temperature value of the first heating area satisfy a preset temperature increase condition; and
the first heating device is stopped if the minimum temperature value and the maximum temperature value of the first heating area satisfy a preset temperature reduction condition.

In an actual implementation, the temperature increase condition includes: the minimum temperature value being less than a lowest temperature threshold value, and the maximum temperature value being less than a highest temperature threshold value.

In an actual implementation, the temperature reduction condition includes: the minimum temperature value being greater than or equal to the lowest temperature threshold value, or the maximum temperature value being greater than or equal to the highest temperature threshold value.

In an actual implementation, the second processor 501 is also configured to execute temperature control programs stored in the second memory 502 to implement the following steps: the lowest temperature threshold value and the highest temperature threshold value corresponding to each working mode of the cookware are preset; and the lowest temperature threshold value and the highest temperature threshold value of the cookware in the current working mode are determined.

In an actual implementation, the cookware further includes: a second heating device to an N^{th} heating device, and a plurality of temperature sensors arranged at different positions of an i^{th} heating area. The i^{th} heating area corresponds to an i^{th} heating device, in which i is an integer of 2 to N. The second processor 501 is also configured to execute temperature control programs stored in the second memory 502 to implement the following steps: temperature values detected by the plurality of temperature sensors in the i^{th} heating area are collected; a minimum temperature value and a maximum temperature value of the i^{th} heating area are determined from all the collected temperature values; the i^{th} heating device is started if the minimum temperature value and the maximum temperature value of the i^{th} heating area satisfy the preset temperature increase condition; and the i^{th} heating device is stopped if the minimum temperature value and the maximum temperature value of the i^{th} heating area satisfy the preset temperature reduction condition.

In an actual implementation, the second processor 501 is also configured to execute temperature control programs stored in the second memory 502 to implement the following steps: the lowest temperature threshold value and the highest temperature threshold value corresponding to each working mode of each heating area are preset; and the lowest temperature threshold value and the highest temperature threshold value of each heating area in the current working mode are determined.

In an actual implementation, the plurality of temperature sensors are in a form of a radial distribution or a lattice distribution.

In an actual implementation, the above-mentioned first processor 401 and second processor 501 may be at least one of Application Specific Integrated Circuit (ASIC), Digital Signal Processing Device (DSPD), Programmable Logic Device (PLD), Field-Programmable Gate Array (FPGA), Micro Processor Unit (MPU) or Digital Signal Processor (DSP). It may be understood that, for different devices, the electronic elements used to implement the functions of the above-mentioned processors may also be other electronic elements, which are not specifically limited in the embodiments of the disclosure.

Each of the above-mentioned first memory 402 and second memory 502 may be a volatile memory, such as a Random-Access Memory (RAM); or may be an non-volatile memory, such as a Read-Only Memory (ROM), a flash memory, a Hard Disk Drive (HDD) or a Solid-State Drive (SSD); or may be a combination of the above types of memories, and may provide instructions and data to the processors.

Fifth Embodiment

Based on the same inventive concept, the embodiments of the disclosure further provide a computer readable storage medium. The computer readable storage medium is, for example, a first memory 402 having computer programs which may be executed by the first processor 401 of the temperature control apparatus, or a second memory 502 having computer programs which may be executed by the second processor 501 of the cookware, so that the steps of the method in one or more embodiments mentioned above are implemented.

One skilled in the art should understand that, the embodiments of the disclosure may be provided as a method, a system, or a computer program product. Therefore, the disclosure may be in the form of hardware embodiments, software embodiments, or a combination thereof. Moreover, the disclosure may be in the form of a computer program product that is implemented on one or more computer-usable storage media (including, but not limited to, magnetic disk storage and optical storage) containing computer-usable program codes.

The disclosure is described referring to the flow chart and/or block diagram of the method, device (system) and computer program product according to the embodiments of the disclosure. It should be understood that, each flow and/or block in the flow chart and/or the block diagram and the combination of flow and/or block in the flow chart and/or the block diagram may be realized via computer program instructions. Such computer program instructions may be provided to a processor of a general-purpose computer, a special-purpose computer, a built-in processor or other programmable data processing devices, to produce a machine, so that the instructions executed by the processor of the computer or other programmable data processing devices may produce a device for realizing the functions specified in one or more flows in the flow chart and/or one or more blocks in the block diagram.

Such computer program instructions may also be stored in a computer-readable storage device that can guide a computer or other programmable data processing devices to work in a specific mode, so that the instructions stored in the computer-readable storage device may produce a manufacture including a command device. The command device may realize the functions specified in one or more flows of the flow chart and one or more blocks in the block diagram.

Such computer program instructions may also be loaded to a computer or other programmable data processing devices, so that a series of operational processes may be executed on the computer or other programmable devices to produce a computer-realized processing, so that the instructions executed on the computer or other programmable devices may provide steps for realizing the functions specified in one or more flows in the flow chart and/or one or more blocks in the block diagram.

The above embodiments are only example embodiments of the disclosure and are not intended to limit the scope of the disclosure.

1-10. (canceled)

11. A temperature control method for a cookware comprising:
collecting temperature values detected by a plurality of temperature sensors arranged at different positions of a heating area of the cookware;
determining a minimum temperature value and a maximum temperature value of the heating area from among the collected temperature values;
starting a heating device in response to the minimum temperature value and the maximum temperature value of the heating area satisfying a preset temperature increase condition; and
stopping the heating device in response to the minimum temperature value and the maximum temperature value of the heating area satisfying a preset temperature reduction condition.

12. The method of claim 11, wherein the temperature increase condition includes the minimum temperature value being less than a lowest temperature threshold value and the maximum temperature value being less than a highest temperature threshold value.

13. The method of claim 12, further comprising:
determining the lowest temperature threshold value and the highest temperature threshold value according to a current working mode;
wherein the current working mode is one of a plurality of working modes of the cookware each having a corresponding lowest temperature threshold value and a corresponding highest temperature threshold value.

14. The method of claim 11, wherein the temperature reduction condition includes the minimum temperature value being greater than or equal to a lowest temperature threshold value or the maximum temperature value being greater than or equal to a highest temperature threshold value.

15. The method of claim 14, further comprising:
determining the lowest temperature threshold value and the highest temperature threshold value according to a current working mode;
wherein the current working mode is one of a plurality of working modes of the cookware each having a corresponding lowest temperature threshold value and a corresponding highest temperature threshold value.

16. The method of claim 11, wherein:
the heating device is a first heating device, the heating area is a first heating area, the plurality of temperature sensors are a plurality of first temperature sensors, the temperature increase condition is a first temperature increase condition, and the temperature reduction condition is a first temperature reduction condition; and
the cookware further includes:
a second heating device; and
a plurality of second temperature sensors arranged at different positions of a second heating area corresponding to the second heating device;
the method further comprising:
collecting temperature values detected by the plurality of second temperature sensors in the second heating area;
determining a minimum temperature value and a maximum temperature value of the second heating area from among the temperature values detected by the plurality of second temperature sensors;
starting the second heating device in response to the minimum temperature value and the maximum temperature value of the second heating area satisfying a second preset temperature increase condition; and
stopping the second heating device in response to the minimum temperature value and the maximum temperature value of the second heating area satisfying a second preset temperature reduction condition.

17. The method of claim 16, wherein the second temperature increase condition includes the minimum temperature value of the second heating area being less than a lowest temperature threshold value and the maximum temperature value of the second heating area being less than a highest temperature threshold value.

18. The method of claim 17, further comprising:
determining the lowest temperature threshold value and the highest temperature threshold value of the second heating area according to a current working mode;
wherein the current working mode is one of a plurality of working modes of the cookware each having a corresponding lowest temperature threshold value and a corresponding highest temperature threshold value for the second heating area.

19. The method of claim 11, wherein the plurality of temperature sensors are distributed in a radial form or in a lattice form.

20. A computer readable storage medium storing computer programs that, when executed by a processor, cause the processor to perform the method of claim 1.

21. A temperature control apparatus for a cookware comprising:
a memory storing temperature control programs; and
a processor configured to execute the temperature control programs to:
collect temperature values detected by a plurality of temperature sensors arranged at different positions of a heating area of the cookware;
determine a minimum temperature value and a maximum temperature value of the heating area from among the collected temperature values;
start a heating device in response to the minimum temperature value and the maximum temperature value of the heating area satisfying a preset temperature increase condition; and
stop the heating device in response to the minimum temperature value and the maximum temperature value of the heating area satisfying a preset temperature reduction condition.

22. A cookware comprising:
a heating device;
a plurality of temperature sensors arranged at different positions of a heating area;
a memory storing temperature control programs; and
a processor configured to execute the temperature control programs to:
collect temperature values detected by the plurality of temperature sensors;
determine a minimum temperature value and a maximum temperature value of the heating area from among the collected temperature values;
start the heating device in response to the minimum temperature value and the maximum temperature value of the heating area satisfying a preset temperature increase condition; and
stop the heating device in response to the minimum temperature value and the maximum temperature value of the heating area satisfying a preset temperature reduction condition.

23. The cookware of claim 22, wherein the temperature increase condition includes the minimum temperature value being less than a lowest temperature threshold value and the maximum temperature value being less than a highest temperature threshold value.

24. The cookware of claim 23, wherein:
the processor is further configured to execute the temperature control programs to:
determine the lowest temperature threshold value and the highest temperature threshold value according to a current working mode; and
the current working mode is one of a plurality of working modes of the cookware each having a corresponding lowest temperature threshold value and a corresponding highest temperature threshold value.

25. The cookware of claim 22, wherein the temperature reduction condition includes the minimum temperature value being greater than or equal to a lowest temperature threshold value or the maximum temperature value being greater than or equal to a highest temperature threshold value.

26. The cookware of claim 25, wherein:
the processor is further configured to execute the temperature control programs to:
determine the lowest temperature threshold value and the highest temperature threshold value according to a current working mode; and
the current working mode is one of a plurality of working modes of the cookware each having a corresponding lowest temperature threshold value and a corresponding highest temperature threshold value.

27. The cookware of claim 22,
wherein the heating device is a first heating device, the heating area is a first heating area, the plurality of temperature sensors are a plurality of first temperature sensors, the temperature increase condition is a first temperature increase condition, and the temperature reduction condition is a first temperature reduction condition;
the cookware further comprising:
a second heating device; and
a plurality of second temperature sensors arranged at different positions of a second heating area corresponding to the second heating device;
wherein the processor is further configured to execute the temperature control programs to:
collect temperature values detected by the plurality of second temperature sensors in the second heating area;
determine a minimum temperature value and a maximum temperature value of the second heating area from among the temperature values detected by the plurality of second temperature sensors;
start the second heating device in response to the minimum temperature value and the maximum temperature value of the second heating area satisfying a second preset temperature increase condition; and
stop the second heating device in response to the minimum temperature value and the maximum temperature value of the second heating area satisfying a second preset temperature reduction condition.

28. The cookware of claim 27, wherein the second temperature increase condition includes at least one of the minimum temperature value of the second heating area being less than a lowest temperature threshold value or the maximum temperature value of the second heating area being less than a highest temperature threshold value.

29. The cookware of claim 28, wherein:
the processor is further configured to execute the temperature control programs to:
determine the lowest temperature threshold value and the highest temperature threshold value of the second heating area according to a current working mode; and
the current working mode is one of a plurality of working modes of the cookware each having a corresponding lowest temperature threshold value and a corresponding highest temperature threshold value for the second heating area.

30. The cookware of claim 22, wherein the plurality of temperature sensors are distributed in a radial form or in a lattice form.
